(19) United States
(12) Patent Application Publication
(10) Pub. No.: US 2013/0051861 A1
(43) Pub. Date: Feb. 28, 2013

(54) ANGLED MAGNETIC AUGER FOR A DEVELOPER STATION

(71) Applicant: Alan E. Rapkin, Pittsford, NY (US)

(72) Inventor: Alan E. Rapkin, Pittsford, NY (US)

(21) Appl. No.: 13/214,460

(22) Filed: Aug. 22, 2011

(51) Int. Cl. G03G 15/08

(52) U.S. Cl. 399/255

(57) ABSTRACT

A method of applying toner to a photoconductor in an electrophotographic printing apparatus includes feeding developer from a feed auger channel to a roller; transferring toner from the development roller to a photoconductor; removing depleted developer from the development roller to a return auger channel; refreshing the depleted developer with fresh toner; combining the refreshed developer with unused developer in the feed auger channel; transferring the combined refreshed developer to a mixing channel; transferring the mixed developer to the feed auger channel; and wherein an axis of the development roller is tilted with respect to an axis of the toning roller.

### CROSS REFERENCE TO RELATED APPLICATIONS

Reference is made to commonly-assigned copending U.S. patent application Ser. No. ______ (Attorney Docket No. K000534USO1NAB), filed herewith, entitled ANGLED MAGNETIC AUGER FOR A DEVELOPER STATION, by Rapkin; the disclosure of which is incorporated herein.

### FIELD OF THE INVENTION

The present invention relates in general to electrophotographic printing and in particular to an improved agar for a developer station.

### BACKGROUND OF THE INVENTION

The three channel development system used in electrophotographic printers has a development roller that moves developer containing toner into proximity with a primary imaging member, usually a photoconductor; and a first channel containing a feed auger, a second channel containing a return auger, a third channel containing a mixing auger. The primary imaging member is used for forming an electrostatic image. The developer used in development systems of this type usually contains magnetic particles and marking particles. The marking particles are removed from the development system to form an image on the primary imaging member.

The flow of developer through the three channel development system is such that developer is fed from the third channel to a first end of the feed auger in the first channel. As the developer travels longitudinally down the length of the feed auger, a portion of the developer is fed transversely from the feed auger to the development roller to produce a layer of developer on the development roller. The remainder of developer in the first channel continues to travel longitudinally down the length of the feed auger.

To produce a uniform image, the layer of developer on the development roller should be uniform along its length. The developer that is fed to the development roller moves over the development roller and is not returned to the feed auger but instead drops into the return auger in the second channel. Consequently, the volume of developer in the first channel decreases along the length of the first channel in the direction of developer flow along the first channel.

Developer moves longitudinally in the same direction in both the first channel and the second channel, from the first end of the augers to the second end, which is at the rear or drive end of the development system. At the rear of the development system, the developer collected by the second channel and the remaining developer in the first channel are both dropped into the third channel. It is also at this point that replenishment marking particles are added to the developer to replace the marking particles that have been applied to the primary imaging member. The developer is moved transversely along the third channel by the mixing auger, toward the first end of the feed auger. The developer that has traveled the length of the third channel is fed to the first end of the feed auger in the first channel, so that the developer is cycled continuously from the first channel to the development roller while the development system is running

In comparison, one channel or two channel development system designs often have the characteristic that developer that has travelled over the development roller is dropped back into the channel from which it was fed to the development roller. Some of this developer will have had marking particles removed by the image. In other words, the concentration of marking particles in the developer is reduced as the developer is used for image development, returned to the feed auger, and subsequently travels down the feed auger of a one channel or two channel development system. As the toner concentration decreases, the developed mass and image density also decrease undesirably.

An advantage of the three channel design compared to a one channel or two channel design is that the marking particle concentration is maintained down the length of the first channel. However, the volume of developer in the first channel does not remain constant down its length, usually resulting in more developer on the development roller near the first end of the feed auger, where there is a relatively large volume of developer in the first channel. Near the second end of the feed auger, where there is a relatively small volume of developer, there is usually less developer on the development roller.

It is advantageous to have a constant mass flow of developer at any point along the entire length of the development roller as well as having a constant marking particle concentration in the developer that is presented to the primary imaging member via the development roller. Specifically, it is advantageous to have a means of maintaining the developer feed to the development roller despite the reduction in developer volume down the length of the first channel.

### SUMMARY OF THE INVENTION

Briefly, according to one aspect of the present invention a method of applying toner to a photoconductor in an electrophotographic printing apparatus includes feeding developer from a feed auger channel to a roller; transferring toner from the development roller to a photoconductor; removing depleted developer from the development roller to a return auger channel; refreshing the depleted developer with fresh toner; combining the refreshed developer with unused developer in the feed auger channel; transferring the combined refreshed developer to a mixing channel; transferring the mixed developer to the feed auger channel; and wherein an axis of the development roller is tilted with respect to an axis of the toning roller.

One embodiment of the invention tips the feed auger relative to the development roller such that the development roller is substantially parallel to the developer level of the feed channel, not parallel to the axis of the feed auger as is typical. The invention and its objects and advantages will become more apparent in the detailed description of the preferred embodiment presented below.

### BRIEF DESCRIPTION OF THE DRAWINGS

FIG. 1 is a cross-sectional view of an electrophotographic printer.

FIG. 2 is a transverse cross-sectional view of a development system for an electrophotographic printer according to an embodiment of the invention.

FIG. 3 is a longitudinal cross-sectional view of a development system for an electrophotographic printer according to an embodiment of the invention.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

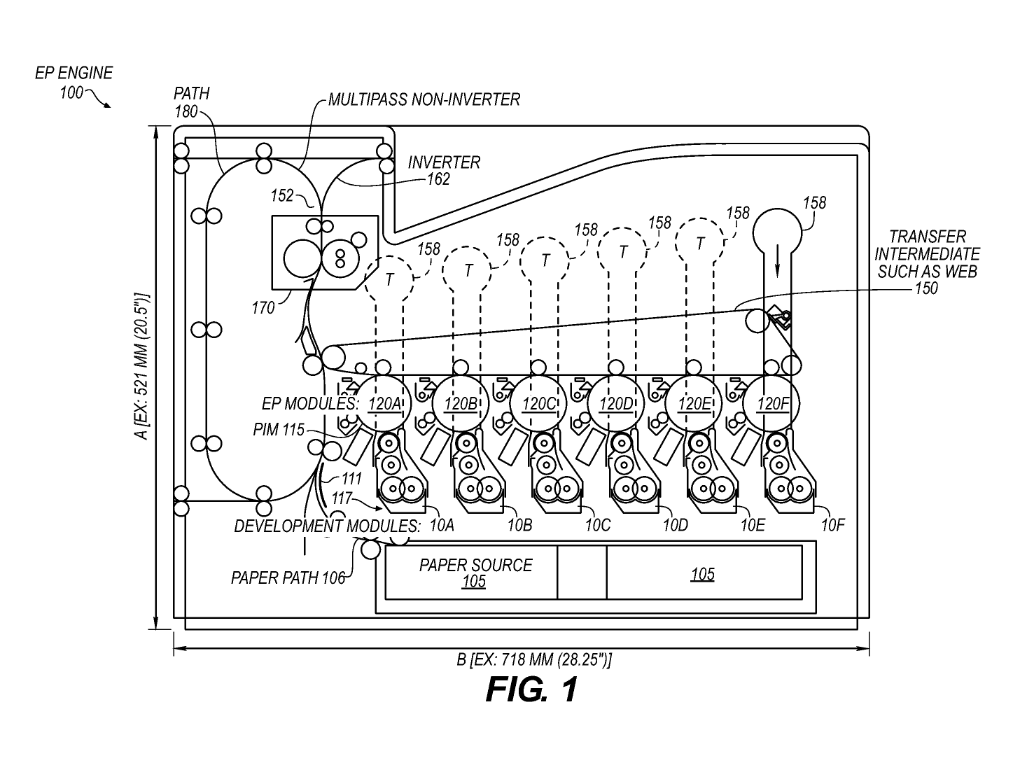

FIG. 1 shows an electrophotographic (EP) engine 100 or printer, often referred to as a tandem print engine including EP modules (120A, 120B, 120C, 120D, 120E, and 120F), wherein each contains a single primary imaging member (PIM) 115 and a single development system (10A, 10B, 10C, 10D, 10E, and 10F) to print on receiver 111. The EP printer is shown having dimensions of A×B which are around in one example, 52×718 mm or less. Development stations 10A-10D would typically contain marking particles that are typically used in most color prints. For example, marking particles having typical optical densities such that a monolayer coverage (i.e. sufficient application of marking particles such that a microscopic examination would reveal a layer of marking particles covering between 60% and 100% of a primary imaging member would have a transmission density in the primarily absorbed light color, as measured using a device such as an X-Rite Densitometer with Status A filters of between 0.6 and 1.0) of the subtractive primary colors cyan, magenta, yellow, and black would typically be contained in four of these development stations. The additional development systems can be used to print specialty marking particles that are commonly used for many applications, selectively determined by a control element. An individual operating or owning (hereafter referred to as the operator) the EP engine could control the control element and this effectively determines which specialty marking particles would print.

For example, a full-color image can be made using marking particles that function as ink containing typical cyan, magenta, yellow, and black subtractive primary colorants such as pigment particles or dyes. The marking particles are contained in a development system that develops an electrostatic latent image and is in proximity to a cylindrical primary imaging member or a frame of a primary imaging member in the form of a continuous web. Additional marking particles corresponding to specialty toners or inks are contained in one of a plurality of development systems, any one of which can be brought into proximity with a primary imaging member bearing an electrostatic latent image and convert that electrostatic latent image into a visible image. For example, the electrophotographic engine shown in FIG. 1 contains six print modules. Four of the modules would each contain a single development system containing marking particles of one of the four subtractive primary colors. The fifth and sixth EP modules 120E and 120F are shown with development systems, each containing marking particles having the function of a distinct specialty ink that can convert an electrostatic latent image into a visible image with only that specific specialty ink.

For example, if clear toner is commonly used as a marking particle by a particular EP engine, the fifth development system 10E could contain clear toner. Alternatively, other marking particles that would be commonly used throughout a variety of jobs can be contained in the fifth EP module. The sixth EP module 120F is also capable of selectively printing a specialty marking particle. Images produced with specialty marking particles include transparent, raised print, magnetic image carrier recognition (MICR) magnetic characters, specialty colors and metallic toners as well as other images that are not produced with the basic color marking particles.

Development systems suitable for use in this invention include dry development systems containing two component developers such as those containing both marking particles and magnetic carrier particles. The development systems used for two component development can have either a rotating magnetic core, a rotating shell around a fixed magnetic core, or a rotating magnetic core and a rotating magnetic shell. It is preferred that the marking particles used in practicing this invention are toner that is a component of dry developer. Marking particles are removed from the development system when images are printed. Replacement marking particles are added to the development systems 10A-10F by replenishment stations 158, each of which contain the appropriate marking particle.

In the example shown in FIG. 1, after each development system develops the electrostatic latent image on the primary imaging member (PIM) 115, thereby converting the electrostatic latent image a visible image, each image is transferred, in register, to an intermediate transfer member (ITM) 150. The ITM can be in the form of a continuous web as shown or can take other forms such as a drum or sheet. It is preferable to use a compliant intermediate transfer member, such as described in the literature, but noncompliant ITMs can also be used.

The receiver sheets are held in the printer at a paper tray (paper source) 105 and, in the example shown, enter the paper path 180 so as to travel initially in a counterclockwise direction. The paper could also be manually input from the left side of the electrophotographic engine. The printed image is transferred from the ITM to the receiver and the image bearing receiver then passes through a fuser 170 where the image is permanently fixed to the receiver. The image then enters a region where the receiver either enters an inverter 162 or continues to travel counterclockwise. If the receiver enters the inverter, it travels clockwise, stops, and then travels counterclockwise back onto the paper path 180. This inverts the image, thereby allowing the image to be duplexed. Prior to the inverter is a diverter 152 that can divert the receiver sheet from the inverter and sends it along the paper path in a counterclockwise direction. This allows multiple passes of the receiver on the simplex side, as might be desired if multiple layers of marking particles are used in the image or if special effects such as raised letter printing using large clear toner are to be used. Operation of the diverter to enable a repeat of simplex and duplex printing can be visualized using the paper path 180 shown in FIG. 1.

It should be noted that, if desired, the fuser 170 can be disabled so as to allow a simplex image to pass through the fuser without fusing, if desired. This might be the case if an expanded color balance in simple printing is desired and a first fusing step might compromise color blending during the second pass through the EP engine. Alternatively, a fusing system that merely tacks, rather than fully fuses, an image and is known in the literature can be used if desired such as when multiple simplex images are to be produced. The image can also be sent through a subsystem that imparts a high gloss to the image, as is known in the literature and is described in co-owned U.S. Pat. Nos. 7,212,772; 7,324,240 and 7,468,820 as well as U.S. Publications 2008/159786 and 2008/050667, which are hereby incorporated by reference.

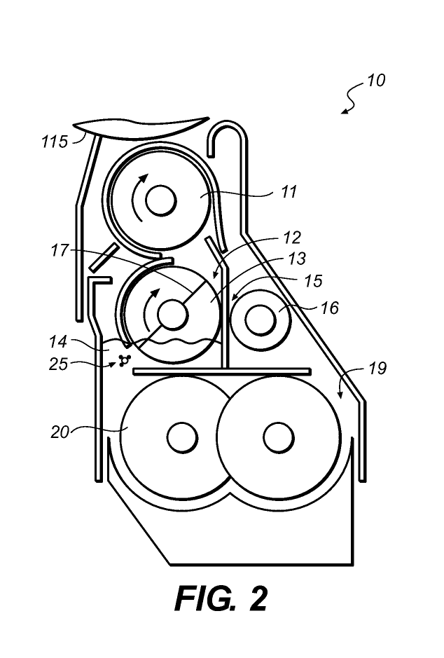

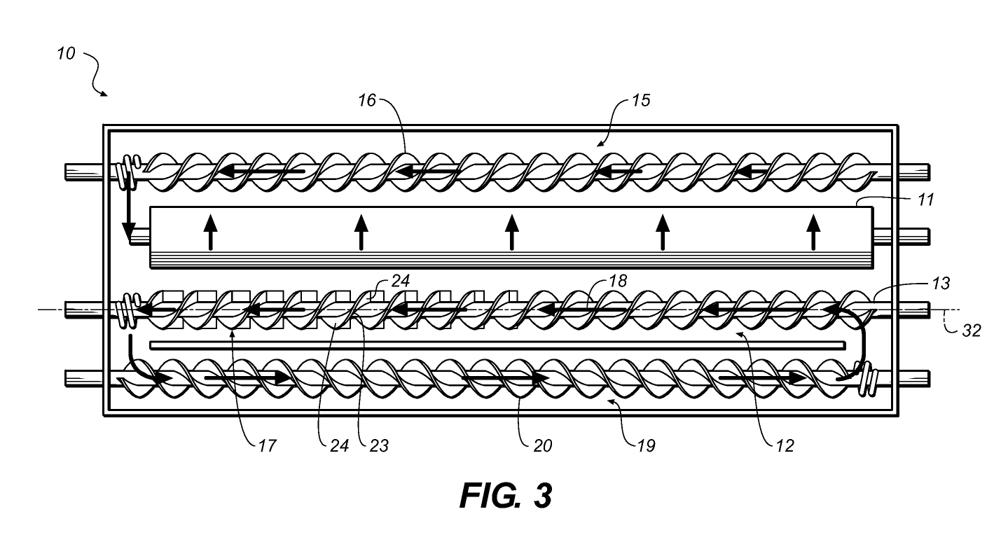

Referring now to FIG. 2 and FIG. 3, an arrangement of a development roller 11 whose axis is tipped relative to the feed auger 13 axis 32 of development system 10 but substantially parallel to the developer level of the feed channel 12. In this manner, the feed of developer to the development roller is assisted and remains substantially uniform as the volume of developer in the first channel decreases. FIG. 2 is a transverse cross-sectional view of a development system 10 for an electrophotographic printer according to an embodiment of the invention. A development roller 11 is adjacent a feed auger 13 in a first channel 12. The cross-sectional view of FIG. 2 shows a low volume of developer 14 containing magnetic particles and marking particles 25 (not to scale), with the marking particles represented schematically as a filled-in circle and the magnetic particles as an unfilled circle. Developer is fed from the first channel 12 to the development roller 11, is moved to proximity with primary imaging member 115, and drops into second channel 15 with second auger 16. At the rear of the development system, the developer collected by the second channel 15 and the remaining developer in the first channel 12 are both dropped into the third channel 19, where at least a third auger 20 moves the developer to the front of the station, where it is fed to the first end of the feed auger 13 in the first channel 12.

FIG. 3 is a longitudinal cross-sectional schematic view of a development system for an electrophotographic printer according to an embodiment of the invention that shows a direction of developer flow 18 in the first channel 12 along an axis of the feed auger 32 shown with flight 23 and working face 24. The decreasing volume of developer in the first channel 12 is indicated by the decreasing length of the arrows 18 in the direction of developer flow. Uniform flow of developer over the development roller 11 is indicated by similar arrows of the same size. Increasing volume of developer in the second channel 15 is indicated by the increasing length of the arrows in the direction of developer flow. The arrows also indicate that developer from the first channel and the second channel is collected in the third channel 19, where it is mixed and fed to the first channel.

The invention has been described in detail with particular reference to certain preferred embodiments thereof, but it will be understood that variations and modifications can be effected within the scope of the invention.

### Parts List

10 development system

10A-10F development system

11 development roller

12 first channel

13 feed auger

14 developer

15 second channel

16 second auger

18 direction of developer flow

19 third channel

20 third auger

23 auger flight

24 working face of auger

25 magnetic particles and marking particles

32 axis of the feed auger

100 electrophotographic (EP) engine or printer

105 paper source

111 receiver

115 primary imaging member (PIM)

120A-120F electrophotographic (EP) module

150 intermediate transfer member (ITM)

152 diverter

158 replenishment station

162 inverter

170 fuser

180 paper path

1. A method of applying toner to a photoconductor in an electrophotographic printing apparatus comprising:
feeding developer from a feed auger channel to a toning roller;
transferring toner from the toning roller to a photoconductor;
removing depleted developer from the toning roller to a return auger channel;
refreshing the depleted developer with fresh toner;
combining the refreshed developer with unused developer in the feed auger channel;
transferring the combined refreshed developer to a mixing channel;
transferring the mixed developer to the feed auger channel; and
wherein an axis of the feed auger is tilted with respect to an axis of the toning roller.

2. The method of claim 1 wherein an auger in the feed auger channel moves in a direction parallel to an auger in the returned auger channel.

3. The method of claim 1 wherein there is no mixing between the feed auger channel and the return of auger channel.

4. The method of claim 1 wherein a uniform amount of developer is applied to the toning roller along an axis of the toning roller.

5. The method of claim 1 wherein a height of developer in the feed auger channel is a constant distance from a surface of the toning roller.
